(19) United States
(12) Patent Application Publication
(10) Pub. No.: US 2008/0005762 A1
(43) Pub. Date: Jan. 3, 2008

(54) Data broadcast playback apparatus and method of the same

(75) Inventor: Koji Seko, Mitaka-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/812,834

(22) Filed: Jun. 22, 2007

(30) Foreign Application Priority Data
Jun. 30, 2006 (JP) 2006-182046

(51) Int. Cl. H04N 7/10

(52) U.S. Cl. 725/32

(57) ABSTRACT

According to one embodiment, a data broadcast playback apparatus allows the user to select and view either of a recorded data broadcast and a latest data broadcast when viewing a data broadcast. When an instruction to play back a data broadcast is provided while a content read from a recording medium by a recording apparatus is being played back, a check section checks at least one of the following items: (1) whether a data broadcast is being provided on a channel, from which the recorded content being played back at present was obtained, (2) whether a data broadcast is being provided on a channel selected at present, and (3) whether the recorded content which is being played back at present includes data of a data broadcast. The apparatus displays a check result on a display, receives an operation input, and thereby plays back a data broadcast of a selected item.

### CROSS-REFERENCE TO RELATED APPLICATIONS

This application is based upon and claims the benefit of priority from Japanese Patent Application No. 2006-182046, filed Jun. 30, 2006, the entire contents of which are incorporated herein by reference.

### BACKGROUND

1. Field

One embodiment of the invention relates to a data broadcast playback apparatus and method of the same that are effectively applied to an apparatus obtained by combining a recording and playback apparatus, which records broadcast programs on recording media and plays back recorded programs, with digital broadcast signal receiving tuners.

2. Description of the Related Art

In digital broadcasting, it is possible to include a plurality of transport streams in one channel. Further, it is possible to include data broadcasting packets in streams. Service information in transport streams includes information indicating what stream is being sent.

There have been developed digital broadcast receivers obtained by combining a tuner which receives the digital broadcasts with a recording apparatus (for example, Jpn. Pat. Appln. KOKAI Pub. No. 2005-65152). In this document, it is distinguished whether the receiver is in a state of receiving broadcasting waves, or in a state of playing back a recorded program, and reference viewer data of different regions are used for respective states. The viewer data is information about viewer's names, telephone numbers, and answers to quiz programs concerning data broadcasts, and is transmitted to the broadcasters through communication networks.

The above digital broadcast receiver equipped with a recording apparatus separates a packet elementary stream (referred to as “content”) from a transport stream of a selected channel, and records the packet elementary stream. If the stream includes data broadcasting packets, the data broadcasting packets are simultaneously recorded.

Therefore, the above digital broadcast receiver equipped with a recording apparatus can also decode and play back data of the data broadcasting packets, if “data broadcast playback” is instructed when playing back the stream.

Examples of data broadcasts are quiz, weathercasts, and late news, etc. Therefore, if contents are recorded by the recording apparatus and the contents and a data broadcast contained therein are played back several days later, the user cannot view the latest weathercast or latest news.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram of a configuration of an apparatus, to which the present invention is applied.

FIG. 2 is a flowchart illustrating an example of operation of the apparatus shown in FIG. 1.

FIGS. 3A to 3C are diagrams illustrating display examples of a display of the apparatus shown in FIG. 1.

### DETAILED DESCRIPTION

Various embodiments according to the invention will be described hereinafter with reference to the accompanying drawings.

This embodiment is aimed at providing a data broadcast playback apparatus and a method of the same, which enables the user to select and view either of recorded data broadcasts and latest data broadcasts when the user views a data broadcast.

According to an aspect of the present invention, the apparatus comprises a check section which performs a check to check at least whether a broadcast channel, from which the content being played back at present has been obtained, is providing a current data broadcast, when an instruction to play back a data broadcast is provided while the content read from the recording medium is being played back; a notifying section which outputs a result of the check to a display section; an interface processing section which receives an operation input for the result of the check displayed on the display section; and a playback control section which causes the data processing section to play back data of the current data broadcast in response to the operation input, when the current data broadcast is being provided.

According to the above structure, if any data broadcasts exist, the user can view the latest data broadcast being broadcasted now on a channel related to the content which is being played back. Therefore, the user can view the latest data broadcast which belongs, with a high probability, to the same category or genre as that of the recorded data broadcast.

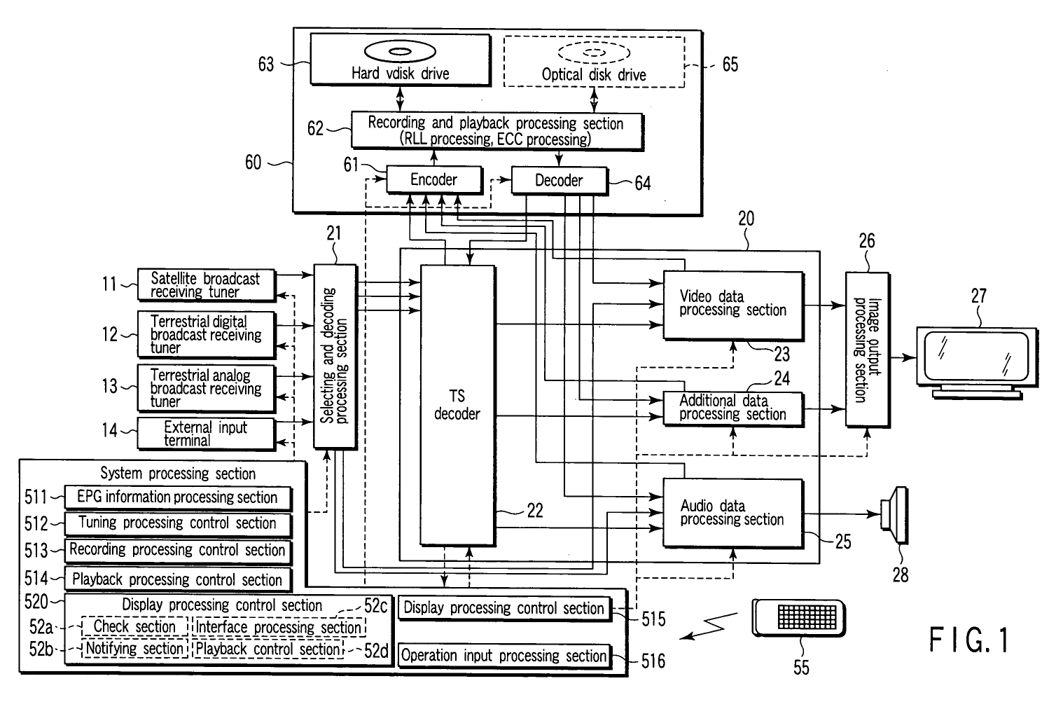

An embodiment of the present invention is explained with reference to drawings. FIG. 1 illustrates a receiving apparatus to which the present invention is applied.

As a basic structure, the receiving apparatus has digital tuners such as a satellite broadcast receiving tuner 11 and a terrestrial digital broadcast tuner 12. Further, the receiving apparatus has a recording and playback section 60 which records and plays back selected contents received by the digital tuners. The receiving apparatus also has a data processing section 20 which converts contents played back by the recording and playback section 60 into display data. The receiving apparatus also has a system control section 51.

FIG. 1 illustrates a hard disk driver 63. Although the receiving apparatus is illustrated in FIG. 1 as an apparatus which can deal with a hard disk as a recording medium, the receiving apparatus may be an apparatus which can deal with both optical disks such as DVDs and a hard disk. In the latter case, the receiver is provided with an optical disk driver 65. The hard disk or optical disks such as DVDs may be replaced by a recording medium such as a semiconductor memory.

The receiving apparatus is equipped with the satellite broadcast tuner 11, the terrestrial digital broadcast tuner 12, and a terrestrial analogue broadcast tuner 13, etc., and can receive various broadcast signals. Further, the receiving apparatus is also provided with an external input section 14. A selecting and decoding processing section 21 selects and outputs one of signals from the tuners and the external input section 14. When a digital broadcast signal is processed, a transport stream is output.

Reference number 22 denotes a transport stream decoder (referred to as the “TS decoder” hereinafter), which selects a packet elementary stream from a selected stream. Then, the TS decoder 22 separates packets from the stream. Control packets of the stream are input to and analyzed in the system control section 51. The system control section 51 analyzes data in the control packets, and ascertains attribute of data in the transmitted stream.

Among data in the packets, demodulated video data and audio data are input to a video data processing section 23 and an audio data processing section 25, respectively. Further, if the packets include data of data broadcasts and other additional data, such data are transmitted to an additional data processing section 24.

Video signals and audio signals which are analogue signals and not in the form of transport stream are digitized by the selecting and decoding processing section 21, and directly input to the video data processing section 23 and the audio data processing section 25, respectively.

An image output processing section 26 processes video data in accordance with the display capability of a display 27, and combines the video data with additional data from the additional data processing section 24. Video signal obtained consequently is supplied to the display 27. Output of the audio data processing section 25 is supplied to a speaker system 28.

Next, operation of the receiver when content is recorded by the recording apparatus is explained. Content transmitted by digital broadcasting is separated by the TS decoder 22 and input to an encoder 61. In the encoder 61, the content is converted to a predetermined format (for example, the HD DVD standard). The encoder 61 uses a buffer memory (not shown).

The formatted content is subjected to run length limited processing and error correction code (ECC) processing by a recording and playback processing section 62, and then supplied to the hard disk driver 63.

If the receiving apparatus has both the hard disk driver 63 and the optical disk driver 65, it is selected according to a command from the control section 51 to which of the disk drivers 63 and 65 a modulation signal is input. The disk drivers 63 and 65 have a rotation control system, and laser drive system or optical system for hard disk and optical disk, respectively.

In the hard disk driver 63, a signal read from the hard disk is subjected to error correction processing by an ECC processing section of the recording and playback processing section 62, and RLL rule removal by an RLL processing section of the recording and playback processing section 62, and input to a decoder 64. If the content includes a digital broadcast signal, the content is temporarily returned to the TS decoder 22. Thereafter, the processing described above is performed by the TS decoder 22.

The encoder 61 may be supplied with digital video signals from the video data processing section 23, additional data from the additional data processing section 24, and digital audio data from the audio data processing section 25. These signals are encoded by the encoder 61, and recorded on the hard disk. When the signals are played back next, decoded output of the decoder 64 is returned to the video data processing section 23, the additional data processing section 24, and the audio data processing section 25.

In the decoder 64, content of DVD format is subjected to packet separation, and divided into an audio stream and a video stream, etc. The audio stream is subjected to PCM demodulation or MPG demodulation. The video stream is subjected to, for example, MPEG2 demodulation.

The additional data processing section 24 processes additional data (such as data of data broadcasts and closed caption data).

The control section 51 includes a microcomputer, and controls each block of the recording apparatus.

The control section 51 can connect the apparatus to external networks through a network interface (not shown). Thereby, the control section 51 can capture a dynamic electronic program guide (EPG) from an external server.

The control section 51 has an EPG information processing section (program guide information processing section having a program guide information table) 511, and a tuning processing control section 512 which controls the tuners and the like. Further, as basic control means, the control section 51 includes a recording processing control section 513, and a playback processing control section 514. The control section 51 also includes a display processing control section 515. The display processing control section 515 outputs a screen image serving as graphic user interface, in response to operation of the user. The control section 51 also includes an operation input processing section 516 which processes operation signals from a remote controller 55, and operation signals from a key input section. The operation input processing section 516 enables input of operation signals such as recording, playback, deletion, tuning, and channel selection. Further, operation signals for playing back data broadcasts are input to the apparatus by the operation input processing section 516.

In particular, the control section 51 includes a data broadcast output control section 520. Operation relating to the control section 520 is explained in detail below.

In particular, the data broadcast output control section 520 also includes a check section 52a, and a notifying section 52b which outputs a check result of the check section 52a to the display 27 through the display processing section 515. The data broadcast output control section 520 also has an interface processing section 52c which receives operation inputs for the check result displayed on the display 27. Further, the data broadcast output control section 520 also has a playback control section 52d which causes the data processing section to play back data of data broadcast, in accordance with operation input received by the interface processing section 52c. For example, if the latest data broadcast is being performed, the playback control section 52d causes the data processing section to play back data of the latest data broadcast.

Further, the control section 51 executes detection of defective parts, detection of unrecorded areas, setting of recording information recording position, UDF recording, and setting of AV address, by using a RAM as work area, in accordance with a control program stored in a ROM thereof. The control section has various information processing sections necessary for performing centralized control of each block of the apparatus, and has a work RAM, a directory detecting section, a whole video management (VMG) information generating section, a packet header processing section, and a sequence header processing section, etc. The control section 51 also has a management information control section for performing recording, and a management information control section for performing edits.

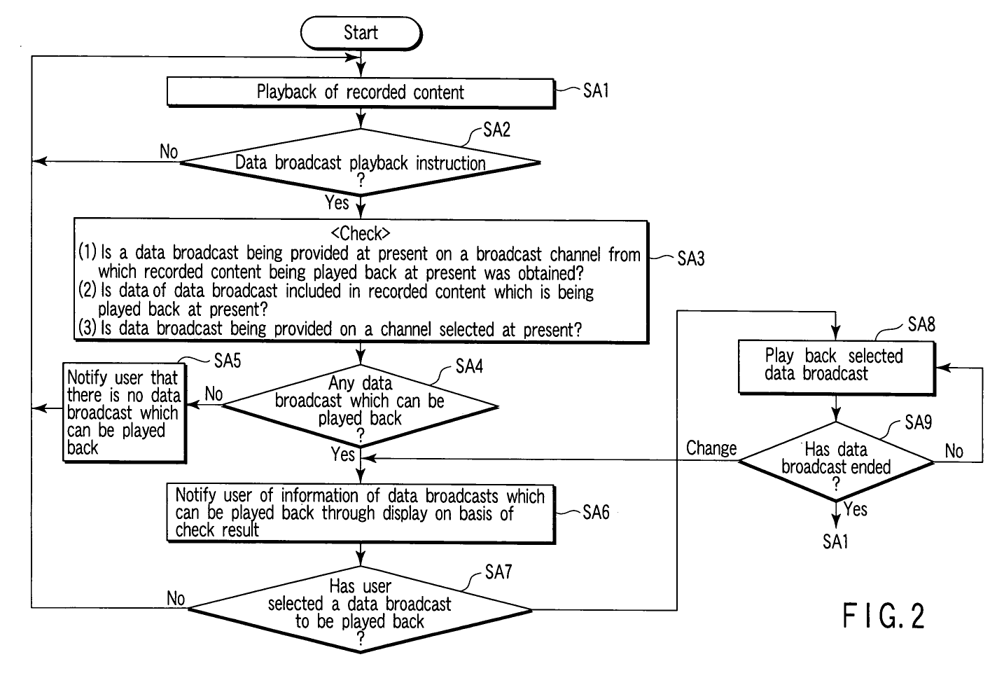

FIG. 2 illustrates an example of operation performed when content including data of a data broadcast explained above is recorded on, for example, the hard disk and the content is played back several days later.

Playback of the recorded content is started (Step SA1). During the playback, suppose that the user operates the remote controller 55, and provides an instruction to play back a data broadcast (Step SA2). Suppose that the content which is being played back includes data of a data broadcast.

Then, the check section functions and performs a check concerning the following items (Step SA3):

(1) Is any data broadcast being provided on the channel from which the recorded content being played back at present was obtained?

(2) Is any data broadcast being performed on a channel which is selected at present?

(3) Does the recorded content being played back at present include data of a data broadcast?

Suppose that it has been proved as a result of the check that data of data broadcast can be played back in any of the above cases (1) to (3). Then, it is checked whether there are any data broadcasts which can be played back (Step SA4). Thereafter, through the display 27, the notifying section 52b notifies the user of information of data broadcasts which can be played back.

The user selects a desired item (desired data broadcast) on the display 27 by operating the remote controller 55, and operates a select key (ENTER key). Thereby, the interface processing section 52c determines that the user has selected a data broadcast to be played back, and causes the playback processing section 52d to play back the selected data broadcast (Step SA8).

If there is no instruction to play back a data broadcast in Step SA2, playback of the recorded content is continued. Further, as a result of check, if there are no data broadcasts which can be played back in Step SA4, the notifying section notifies the user thereof, and the apparatus returns to Step SA1. Further, if the user does not select a data broadcast for a predetermined time or the user performs a cancel operation, the apparatus returns to Step SA1 and continues playback of the content. Further, if playback of the selected data broadcast ends in Step SA9, the apparatus returns to step SA1. Furthermore, if a change key is operated in Step SA9, the apparatus returns to Step SA6, and displays a list of data broadcasts which can be played back.

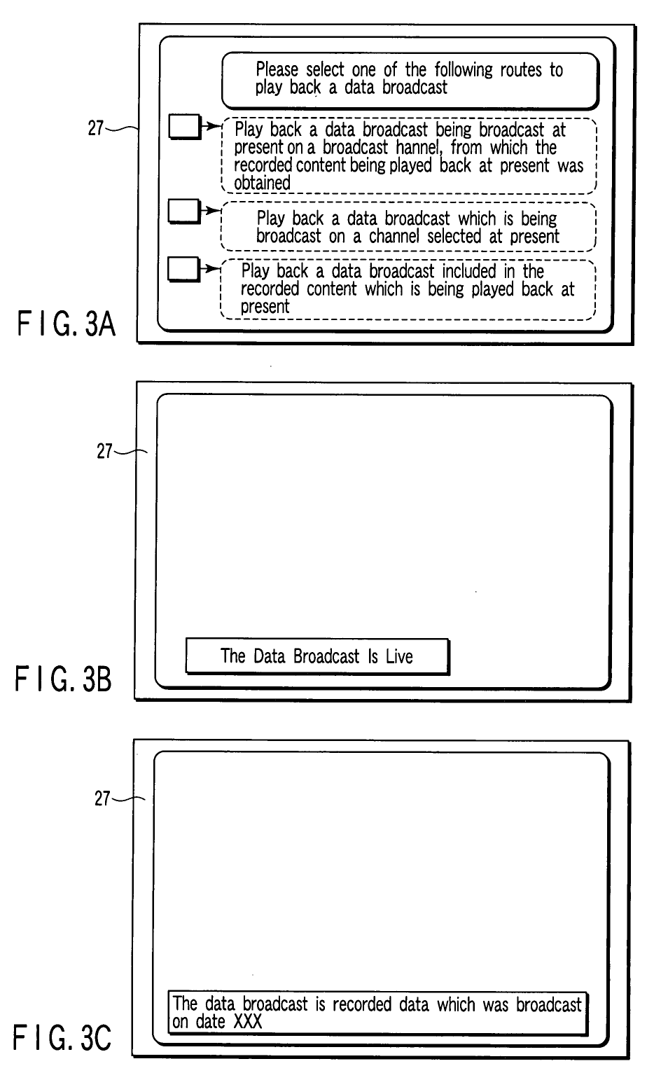

FIG. 3A illustrates an example in which the display 27 displays a menu of data broadcasts which can be played back. The user selects one of marks (1), (2) and (3) by the cursor by operating the remote controller 55. Supposing that one of items (1) and (2) is selected and playback of the data broadcast is started, a subtitle “the data broadcast is live” is displayed for a predetermined time as illustrated in FIG. 3. If the item (3) is selected, a subtitle “the data broadcast is recorded data which was broadcasted on Date XXX” is displayed for a predetermined time as illustrated in FIG. 3C.

As described above, according to the apparatus, the check section 52a performs a check as to:

(1) whether any data broadcast is being provided on the channel, from which the recorded content being played back at present was obtained;

(2) whether any data broadcast is being provided on a channel which is selected at present; and

(3) whether the recorded content being played back at present includes data of a data broadcast.

Then, the notifying section 52b causes the display 27 to display the check result of the above items (1) to (3).

Then, if a data broadcast of the above items (1) or (2) is selected and played back, the interface processing section 52c produces a comment on the display 27 that the data broadcast is live. Further, if a data broadcast of the above item (3) is selected and played back, the date when the data broadcast was recorded is displayed as a comment.

Thereby, the apparatus of the present invention provides the viewers with opportunities to obtain and select the past information and the current information, with simple operation. Specifically, if there is a data broadcast of the item (3) and the user wishes to view the past data broadcast (such as past weathercast), the user can provide an instruction to play back the past data broadcast. Further, if there is a data broadcast of the above item (1) or (2) and the user wishes to view the latest data broadcast (such as hurricane information and stock information which change every moment), the user can provide an instruction to play back the latest data broadcast. Further, if there is a broadcast of the above item (1), the user can view the latest data broadcast which is being broadcasted on the channel of the content being played back at present. Consequently, it is highly possible that the category and the genre the latest data broadcast are the same as those of the recorded data broadcast.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data broadcast playback apparatus comprising:
a digital tuner;
a recording and playback section recording a selected content received by the digital tuner on a recording medium;
a data processing section converting the content played back by the recording and playback section into display data;
a check section checking whether at least current data broadcast is being provided on a broadcast channel carried said content, when the content read from the recording medium is being played back, and an instruction to play back a data broadcast is provided;
a notifying section outputting a result of the check to a display section;
an interface processing section receiving an operation input for the result of the check displayed on the display section; and
a playback control section controlling the data processing section to play back data of the current data broadcast in response to the operation input, when the current data broadcast is being provided.

2. A data broadcast playback apparatus according to claim 1, wherein
the check section also checks whether a data broadcast is being provided on a channel selected by the tuner at present.

3. A data broadcast playback apparatus according to claim 1, wherein
the check section also checks whether a data broadcast is being provided on a channel selected at present, and whether the content which is being played back at present includes data of a data broadcast.

4. A data broadcast playback apparatus according to claim 1, wherein
the check section checks:
(1) whether a data broadcast is being provided on a channel, from which the recorded content being played back at present has been obtained;
(2) whether a data broadcast is being provided on a channel selected at present; and
(3) whether the recorded content which is being played back at present includes data of a data broadcast,
the notifying section displays a check result of the items (1), (2) and (3) on the display, and
the interface processing section displays a comment that the data broadcast is live, when the data broadcast of the item (1) or (2) is selected and played back, and displays a date of recording the data broadcast as a comment, when the data broadcast of the item (3) is selected and played back.

5. A data broadcast playback method applied an apparatus having a digital tuner, a recording and playback section recording a selected content received by the digital tuner on a recording medium, a data processing section converting the content played back by the recording and playback section into display data, and a system control section, the method comprising:
checking, by the system control section when an instruction of data broadcast playback is provided from an operation section while the content read from the recording medium is being played back,
(1) whether a data broadcast is being provided on a channel, from which the recorded content being played back at present has been obtained;
(2) whether a data broadcast is being provided on a channel selected at present; and
(3) whether the recorded content which is being played back at present includes data of a data broadcast, and
displaying a check result of the items (1), (2) and (3) on a display, and prompting selection of one of the items (1), (2) and (3).

6. A data broadcast playback method according to claim 5, wherein
a comment that the data broadcast is live is displayed when the data broadcast of the item (1) or (2) is selected and played back, and a date of recording the data broadcast is displayed as a comment when the data broadcast of the item (3) is selected and played back.

7. A data broadcast playback apparatus which allows selection of one of a latest data broadcast and a recorded data broadcast, the apparatus comprising a digital tuner, a recording and playback section which records a selected content received by the digital tuner on a recording medium, and a data processing section which converts the content played back by the recording and playback section into display data,
the apparatus further comprising
a check section which checks the following items, when the content read from the recording medium is being played back:
(1) whether a data broadcast is being provided on a channel, from which the recorded content being played back at present has been obtained;
(2) whether a data broadcast is being provided on a channel selected at present; and
(3) whether the recorded content which is being played back at present includes data of a data broadcast,
and
a notifying section which notifies a display of a check result of the items (1), (2) and (3).

8. A data broadcast playback apparatus according to claim 7, wherein
the recording medium is one of a hard disk and an optical disk.

9. A data broadcast playback apparatus according to claim 7, wherein
a date of broadcasting the data broadcast is displayed, when the data of the data broadcast of the item (3) is displayed.

10. A data broadcast playback apparatus according to claim 7, wherein
a comment that the data broadcast is live is displayed, when data of the data broadcast of the item (1) or (2) is displayed.
